(19) United States
(12) Patent Application Publication
(10) Pub. No.: US 2012/0204242 A1
(43) Pub. Date: Aug. 9, 2012

(54) PROTECTING WEB AUTHENTICATION USING EXTERNAL MODULE

(75) Inventor: Ram COHEN, Tel Aviv (IL)

(73) Assignee: ACTIVEPATH LTD., Petah-Tiqva (IL)

(21) Appl. No.: 13/356,042

(22) Filed: Jan. 23, 2012

Related U.S. Application Data
(60) Provisional application No. 61/438,982, filed on Feb. 3, 2011.

(51) Int. Cl. G06F 21/20; G06F 21/24

(52) U.S. Cl. 726/5; 726/7

(57) ABSTRACT

Systems, methods, computer program products, and networks for protecting web authentication. In some examples a system for protecting web authentication includes a web client and a validator which is external to the web client. In these examples, the validator is configured to enable at least one validation item which is provided to a web server during web user authentication to be protected from possible tampering by the web client.

### CROSS REFERENCE TO RELATED APPLICATIONS

This application claims the benefit of U.S. Provisional No. 61/438,982, filed Feb. 3, 2011, which is hereby incorporated by reference herein.

### TECHNICAL FIELD

The presently disclosed subject matter relates to the field of web authentication.

### BACKGROUND

Users are required to authenticate for various web operations such as when logging on to a web site, performing a financial transaction via a web site, opening a secure message via a web site, etc.

Web authentication has become a target of attack in order to steal user credentials. Some of the attacks employ a client side malicious component (e.g. man in the browser) that compromises the web browser by attaching itself to the web browser and monitoring the browser and/or user activity, including for example the user keystrokes.

To combat these attacks, various methods have been introduced including what is commonly known as a “second factor” which is an additional piece of information required to authenticate the user apart from the user password. Examples of such second authentication factors are a hardware token, sending an SMS message with a one-time additional password, a fingerprint, etc.

### SUMMARY

In one aspect, the disclosed subject matter provides a system for protecting web authentication, comprising: a web client operable to attempt to gain access to a resource provided by a web server which requires web user authentication; and a validator, external to the web client, operable to enable at least one validation item which is provided to the web server during web user authentication to be protected from possible tampering by the web client.

In some embodiments, the system is further operable to collect at least one validation item and provide at least one collected validation item to a validation system, thereby allowing the validation system to generate a validation confirmation relating to at least one validation item provided to the validation system whose validation is confirmed.

In some of these embodiments, the validator being operable to enable includes: being operable to provide instruction to the validation system to provide to the web server at least one validation item, each comprising at least part of a validation item which was provided to the validation system and whose validation is confirmed or at least part of the validation confirmation.

In some of these embodiments, the validator being operable to enable includes: being operable to collect as a validation item, without involvement of the web client, at least part of the validation confirmation, and to provide the at least part of the validation confirmation to the web server without involvement of the web client.

In some of these embodiments, the validator being operable to enable includes: being operable to provide instruction to the validation system to encrypt and/or sign at least part of the validation confirmation. In some cases, the web client is further operable to provide the encrypted and/or signed at least part of the validation confirmation to the web server.

In some embodiments, the system further comprises: a storer operable to store at least one validation item, wherein the system is further operable to collect at least one of the at least one stored validation item.

In some embodiments, the system further comprises: a user input operable to input at least one validation item from the user, wherein the system is further operable to collect at least one of the at least one inputted validation item.

In some embodiments of the system, the validator being operable to enable includes: being operable to collect at least one validation item without involvement of the web client and to provide to the web server without involvement of the web client at least one validation item, each comprising at least part of a collected validation item.

In some embodiments of the system, the validator being operable to enable includes: being operable to collect without involvement of the web client at least one validation item, and to encrypt and/or sign at least one validation item, each comprising at least part of a collected validation item.

In some of these embodiments, the web client is further operable to provide at least one encrypted and/or signed validation item to the web server.

In some embodiments of the system, the web client is further operable to collect at least one validation item.

In some embodiments of the system, at least one validation item which is provided to the web server during the web user authentication is provided by the web client.

In some embodiments, the system is further operable to determine that there is an authentication requirement.

In some of these embodiments, the authentication requirement is determined by performing at least one action selected from a group comprising: using a URL of a webpage of a web site hosted at the web server, examining HTML content of a webpage of a web site hosted at the web server, using a script in a webpage of a web site hosted at the web server, detecting that a password is required, detecting an HTML element with a predefined identifier that is associated with required authentication on a webpage of a website hosted at the web server, detecting usage of a biometric device such as a fingerprint reader, detecting an application programmable interface API in a webpage of a website hosted at the web server, detecting that the user is trying to open a secure message associated with a hosted web site, detecting that the user is trying to confirm an online operation associated with a hosted web site which requires authentication, detecting that the user is trying to log on to a hosted web site, detecting that the web client is attempting to access any resource relating to a hosted web site which requires user authentication, or receiving notification that there is a requirement for authentication from the web server or from a validation system.

In some of these embodiments, the validator is operable to determine an authentication requirement.

In some of these embodiments, the web client is operable to determine an authentication requirement.

In some embodiments, the system further comprises: a validation system operable to generate a validation confirmation relating to at least one validation item provided to the validation system whose validation is confirmed.

In some embodiments, the system further comprises: the web server operable to receive at least one provided validation item which was protected from possible tampering by the client and to allow access to the resource at least partly based on the at least one provided validation item.

In some embodiments, the system is at least one user device, and if necessary the system further comprises additional hardware, software, firmware, or a combination thereof which enables the system to perform any additional functionality associated with the at least one user device.

In some embodiments, the system is at least one element which services multiple user devices, and if necessary the system further comprises additional hardware, software, firmware, or a combination thereof which enables the system to perform any additional functionality associated with the at least one element.

In another aspect, the disclosed subject matter provides a validation system, operable to receive at least one validation item from a user system, to generate a validation confirmation based on at least one of the at least one received validation item whose validation is confirmed, and to provide at least part of the validation confirmation to the user system or to a web server, the at least part of the validation confirmation being provided by the user system or the validation system to the web server during web user authentication relating to an attempt by a web client in the user system to gain access to a resource provided by the web server, wherein if the at least part of the validation confirmation is provided by the validation system to the user system then the at least part of the validation confirmation is encrypted and/or signed by the validation system, or the at least part of the validation confirmation is handled at the user system without involvement of the web client.

In some embodiments, the validation system is not included in the web server.

In some embodiments, the validation system is included in the web server.

In another aspect, the disclosed subject matter provides a web server, operable to receive at least one validation item from a user system or from a validation system, wherein a validator which is external to a web client on the user system had enabled at least one of the at least one validation item to be protected from possible tampering by the web client, and wherein the web server is further operable to allow access to a resource which requires web user authentication at least partly based on the at least one of the at least one validation item.

In another aspect, the disclosed subject matter provides a method of protecting web authentication, comprising: determining that there is an online authentication requirement relating to a resource provided by a web server to which a web client is attempting to gain access; and enabling at least one validation item which is provided to the web server during web user authentication to be protected from possible tampering by the web client.

In some embodiments, the method further comprises: providing at least one validation item to a validation system, thereby allowing the validation system to generate a validation confirmation relating to at least one validation item provided to the validation system whose validation is confirmed.

In some of these embodiments, the enabling includes: providing instruction to the validation system to provide to the web server at least one validation item, each comprising at least part of a validation item which was provided to the validation system and whose validation is confirmed or at least part of the validation confirmation.

In some of these embodiments, the enabling includes: collecting as a validation item, without involvement of the web client, at least part of the validation confirmation, and providing the at least part of the validation confirmation to the web server without involvement of the web client.

In some of these embodiments, the enabling includes: providing instruction to the validation system to encrypt and/or sign at least part of the validation confirmation.

In some embodiments, the method further comprises: collecting at least one validation item by retrieving the at least one item which had been stored.

In some embodiments, the method further comprises: collecting at least one validation item from a user.

In some embodiments of the method, the enabling includes: collecting without involvement of the web client at least one validation item and providing to the web server without involvement of the web client at least one validation item, each comprising at least part of a collected validation item.

In some embodiments of the method, the enabling includes: collecting without involvement of the web client at least one validation item, and encrypting and/or signing at least one validation item, each comprising at least part of a collected validation item.

In some embodiments, the method further comprises: generating a validation confirmation relating to at least one collected validation item whose validation is confirmed.

In some embodiments, the method further comprises: allowing access to the resource based at least partly on at least one provided validation item which was protected from possible tampering by the client

In some embodiments of the method the authentication requirement is determined by performing at least one action selected from a group comprising: using a URL of a webpage of a web site hosted at the web server, examining HTML content of a webpage of a web site hosted at the web server, using a script in a webpage of a web site hosted at the web server, detecting that a password is required, detecting an HTML element with a predefined identifier that is associated with required authentication on a webpage of a website hosted at the web server, detecting usage of a biometric device such as a fingerprint reader, detecting an application programmable interface API in a webpage of a website hosted at the web server detecting that the user is trying to open a secure message associated with a hosted web site, detecting that the user is trying to confirm an online operation associated with a hosted web site which requires authentication, detecting that the user is trying to log on to a hosted web site, detecting that the web client is attempting to access any resource relating to a hosted web site which requires user authentication, or receiving notification that there is a requirement for authentication from the web server or from a validation system.

In another aspect, the disclosed subject matter provides a validation method, comprising: receiving at least one validation item from a user system; generating a validation confirmation based on at least one of the at least one received validation item whose validation is confirmed; and providing at least part of the validation confirmation to the user system or to a web server; wherein the at least part of the validation confirmation is provided by the user system or the validation system to the web server during web user authentication relating to an attempt by a web client in the user system to gain access to a resource provided by the web server; and wherein if the at least part of the validation confirmation is provided by the validation system to the user system then the at least part of the validation confirmation is encrypted and/or signed by the validation system, or the at least part of the validation confirmation is handled at the user system without involvement of the web client.

In another aspect, the disclosed subject matter provides a method of allowing access to a resource provided by a web server which requires user authentication, comprising: receiving at least one validation item from a user system or from a validation system, wherein a validator which is external to a web client on the user system has enabled at least one of the at least one validation item to be protected from possible tampering by the web client; and allowing access to a resource which requires web user authentication at least partly based on the at least one of the at least one validation item.

In another aspect, the disclosed subject matter provides a computer program product comprising a computer useable medium having computer readable program code embodied therein for protecting web authentication, the computer program product comprising: computer readable program code for causing the computer to determine that there is an online authentication requirement relating to a resource provided by a web server to which a web client is attempting to gain access; and computer readable program code for causing the computer to enable at least one validation item which is provided to the web server during web user authentication to be protected from possible tampering by the web client.

In another aspect, the disclosed subject matter provides a computer program product comprising a computer useable medium having computer readable program code embodied therein, the computer program product comprising: computer readable program code for causing the computer to receive at least one validation item from a user system; computer readable program code for causing the computer to generate a validation confirmation based on at least one of the received validation item whose validation is confirmed; and computer readable program code for causing the computer to provide at least part of the validation confirmation to the user system or to a web server; wherein the at least part of the validation confirmation is provided by the user system or the validation system to the web server during web user authentication relating to an attempt by a web client in the user system to gain access to a resource provided by the web server; and wherein if the at least part of the validation confirmation is provided by the validation system to the user system then the at least part of the validation confirmation is encrypted and/or signed by the validation system, or the at least part of the validation confirmation is handled at the user system without involvement of the web client.

In another aspect, the disclosed subject matter provides a computer program product comprising a computer useable medium having computer readable program code embodied therein of allowing access to a resource provided by a web server which requires user authentication, the computer program product comprising: computer readable program code for causing the computer to receive at least one validation item from a user system or from a validation system, wherein a validator which is external to a web client on the user system has enabled at least one of the at least one validation item to be protected from possible tampering by the web client; and computer readable program code for causing the computer to allow access to a resource which requires web user authentication at least partly based on the at least one of the at least one validation item.

### BRIEF DESCRIPTION OF THE DRAWINGS

In order to understand the presently disclosed subject matter and to see how it may be carried out in practice, embodiments will now be described, by way of non-limiting example only, with reference to the accompanying drawings, in which:

FIG. 1 is a block diagram of a network for protecting web authentication, according to some embodiments of the presently disclosed subject matter; and

FIG. 2 is a flowchart illustration of a method for protecting web authentication, according to some embodiments of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

Embodiments of the presently disclosed subject matter relate to protecting web authentication. In some of these embodiments a system for protecting web authentication includes a web client and a validator which is external to the web client. In these embodiments, the validator is configured to enable at least one validation item which is provided to a web server during web user authentication to be protected from possible tampering by the web client.

In the following detailed description, numerous specific details are set forth in order to provide a thorough understanding of the presently disclosed subject mater. However, it will be understood by those skilled in the art that some examples of the presently disclosed subject matter may be practiced without these specific details. In other instances, well-known methods, procedures and components have not been described in detail so as not to obscure the subject matter.

As used herein, the phrase “for example,” “such as”, “for instance”, “e.g.”-, and variants thereof describe non-limiting embodiments of the subject matter.

As used herein, user validation refers to substantiation of the identity of a user (i.e. proving that the user is who he/she is supposed to be). As used herein, user authentication refers to the provision of user credential(s) (or the acceptance of provided user credential(s)) when attempting to gain access (or before allowing access) to a resource. Web (user) authentication refers to the provision of user credential(s) (or the acceptance of provided user credential(s)) when attempting to gain access (or before allowing access) to a resource provided by a web server (e.g. relating to a hosted web site), for instance using standard Hyper Text Transfer Protocol (HTTP) and/or Hyper Text Transfer Protocol Secure (HTTPS). Typically, although not necessarily, user validation occurs prior to user authentication.

Reference in the specification to “one embodiment”, “an embodiment”, “some embodiments”, “another embodiment”, “other embodiments”, “one instance”, “some instances”, “one case”, “some cases”, “other cases” or variants thereof means that a particular feature, structure or characteristic described in connection with the embodiment(s) is included in at least one non-limiting embodiment of the presently disclosed subject matter. Thus the appearance of the phrase “one embodiment”, “an embodiment”, “some embodiments”, “another embodiment”, “other embodiments” one instance”, “some instances”, “one case”, “some cases”, “other cases” or variants thereof does not necessarily refer to the same embodiment(s).

It should be appreciated that certain features, structures, and/or characteristics, which are, for clarity, described in the context of separate embodiments, may also be provided in combination in a single embodiment. Conversely, various features, structures and/or characteristics which are, for brevity, described in the context of a single embodiment, may also be provided separately or in any suitable sub-combination.

Unless specifically stated otherwise, as apparent from the following discussions, it is appreciated that throughout the specification discussions utilizing terms such as “accessing”, “receiving”, “collecting”, “hosting”, “validating”, “providing”, “performing”, “transmitting”, “sending”, “authenticating”, “communicating”, “storing”, “retrieving”, “inputting”, “outputting”, “determining”, “using”, “informing”, “detecting”, “enabling”, “causing”, “obtaining”, “executing”, “allowing”, “attempting”, “processing”, “confirming”, “calling”, “handling”, “comparing”, “involving”, “matching”, “gaining”, “tampering”, “ensuring”, “examining”, “opening”, “grabbing” , “protecting”, “securing”, “instructing”, “encrypting”, “decrypting”, “signing”, or the like, refer to the action and/or processes of any combination of software, hardware and/or firmware. For example, these terms may refer in some cases to the action and/or processes of a machine, that manipulates and/or transforms data into other data, the data represented as physical, such as electronic quantities, and/or the data representing physical objects.

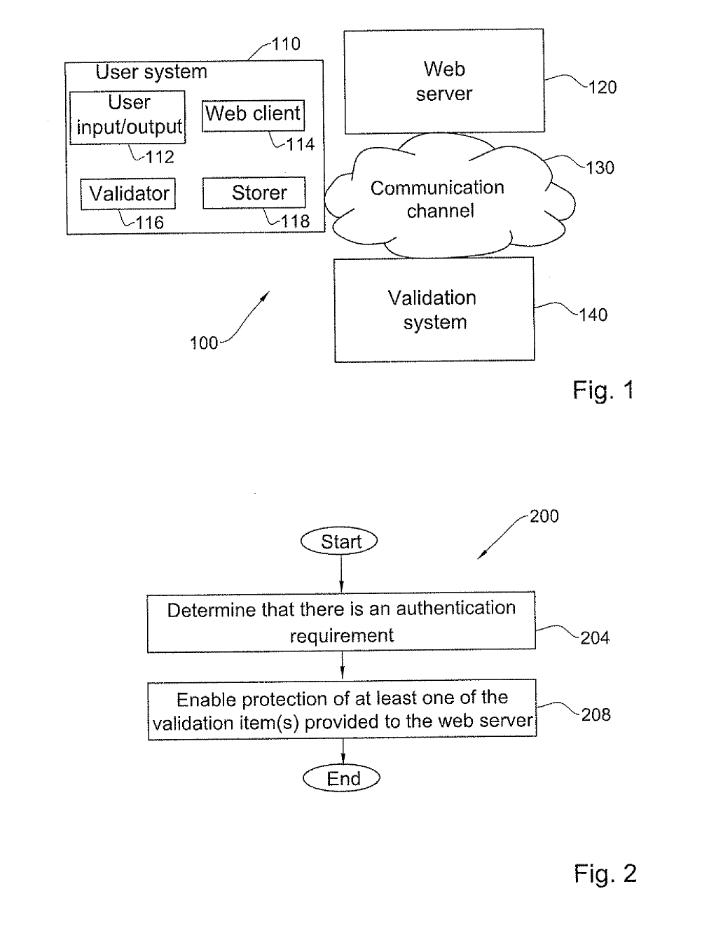

Referring now to the drawings, FIG. 1 schematically illustrates an example of a network 100 for protecting web authentication, according to some embodiments of the presently disclosed subject matter. In the illustrated embodiments, network 100 includes one or more user systems 110, one or more web servers 120, and one or more communication channels 130. Optionally, network 100 may also include one or more validation systems 140. When included, each user system 110, web server 120, and/or validation system 140 may be made up of any combination of hardware, software and/or firmware capable of performing the operations as defined and explained herein. For example, in some embodiments, any of user system(s) 110, web server(s) 120, and/or validation system(s) 140 may comprise a machine specially constructed for the desired purposes, and/or may comprise a programmable machine selectively activated or reconfigured by specially constructed program code. Additionally or alternatively, in some embodiments, any of user system(s) 110, web server(s) 120, and/or validation system(s) 140 may comprise at least some hardware.

For simplicity of illustration and description, user system 110, web server 120, communication channel 130, and validation system 140 are generally referred to below in the single form, but usage of the single form for any particular element should be understood to include both embodiments where there may be one of the particular element in network 100 and embodiments where there may be a plurality of the particular element in network 100.

For simplicity of illustration and description, validation system 140 is separately illustrated and described from web server 120, with communication between validation system 140 and web server 120 shown and described as being via communication channel 130. However, depending on the embodiment, part or all of validation system 140 may be included in web server 120 and/or part or all of validation system 140 may be separate from web server 120.

Features of user system 110 may vary depending on the embodiment. For example, in various embodiments module(s) in user system 110 may be included in one or more user device(s) such as a personal computer, cell phone, smartphone, laptop, tablet computer, etc., may be included in element(s) which service multiple user devices such as proxy server(s), gateway(s), other types of servers, etc, and/or may be included in a combination of the above.

In the illustrated embodiments, user system 110 includes one or more web client modules 114 and one or more validator modules 116. Optionally, user system 110 may also include one or more user input/output modules 112 and/or and one or more storer modules 118. When included, each module in user system 110 may be made up of any combination of hardware, software and/or firmware capable of performing the operations as defined and explained herein. For simplicity of illustration and description, user input/output 112, web client 114, validator 116, and storer 118 are generally referred to below in the single form, but usage of the single form for any particular element should be understood to include both embodiments where there may be one of the particular module in user system 110 and embodiments where there may be a plurality of the particular module in user system 110.

Web client 114 may be configured to attempt to gain access to and/or may be configured to access resource(s) provided by web server(s) such as web server 120 (e.g. relating to website(s) hosted on web server(s) , such as web site(s) hosted on web server 120). Web client 114 may be, for instance, a web browser or any other web application configured to attempt to gain access to and/or configured to access such resource(s). Examples of web client 114 may include any web browser such as Internet Explorer®, Firefox®, Google Chrome™, Safari®, etc which may be currently commercially available or may be available in the future, or any other web application which may be currently commercially available or may be in the future.

Validator 116, external to web client 114, may be configured to enable at least one validation item which may be provided to a web server during web user authentication to be protected from possible tampering by web client 114. It is noted that a validation item is supposed to prove the identity of the user of the web client. If web client 114 has been compromised, then a validation item which is not protected from tampering may be tampered with by web client 114. Tampering may include any malicious use of a validation item. For instance, in some cases, tampering may cause a validation item to no longer prove the identity of the user, and/or may allow another person to assume the identity of the user without permission. Examples of tampering with a validation item may include: changing a validation item, stealing a validation item (e.g. stealing stored user entry/ies and/or passwords from cache or auto-fill functionality data files), recording a validation item including data entry by a particular user (e.g. recording keystroke(s) and/or field value(s)) and using the recorded validation item to validate a different user (allowing the different user to assume the identity of the particular user), intercepting a received and/or stored validation item which may include one or more cookies associated with a particular user and using the intercepted validation item to validate a different user (allowing the different user to assume the identity of the particular user), capturing a validation item associated with a particular user which is being transmitted from a user system to a web server and using the captured validation item to validate a different user (allowing the different user to assume the identity of the particular user), finding a validation item which may include evidence of validation in memory (e.g. breaking into a “save my password file” on a computer disk) and which is associated with a particular user and using the found validation item to validate a different user (allowing the different user to assume the identity of the particular user), extracting or fooling validation item auto-fill functionality (e.g. password and/or field) to fill in recorded values into fields contrary to a particular user's intention, using the validation item of a particular user to gain access to a resource without the knowledge and/or approval of the particular user, using the validation item of a particular user to change the way a resource is being accessed (e.g. change destination of funds transfer by particular user) without the knowledge and/or approval of the particular user, a combination of any of the above, etc.

In various cases, validator 116 may be or may be included in: a plug-in, an add-on, a toolbar or an applet for web client 114; a stand-alone client; any other suitable element in a user device; any other suitable element servicing multiple user devices; and/or an element with any other suitable configuration; etc. Assuming embodiments where validator 116 runs code, depending on the embodiment, validator 116 may or may not run code that is in the same process space as the space of web client 114. In some of these embodiments, validator 116 may or may not spawn a separate operating system process for performing function(s) assigned to validator 116 which may not include all add-ons of web client 114, some of which may be malicious.

Examples of user input/output 112 (when included) may comprise any module configured to input validation item(s) (and optionally other data) and/or configured to output data relating to validation and/or authentication (and optionally other data). Examples of input/output 112 may include keyboard, mouse, camera, keypad, touch-screen display, microphone, speaker, non-touch-screen display, and/or printer, etc. It is noted that when a particular user input module and a particular user output module are described, the particular user input module and particular user output module may be located in the same unit or in separate units, depending on the embodiment. If in separate units, the separate units may or may not be in proximity to each other.

Examples of storer 118 ( when included) may comprise any module configured to store validation item(s) (and optionally other data) for the short and/or long term, locally and/or remotely. Examples of storer 118 may include: any type of disk including floppy disk, hard disk, optical disk, CD-ROMs, magnetic-optical disk, magnetic tape, flash memory, random access memory (RAMs), dynamic random access memory (DRAM), static random access memory (SRAM), read-only memory (ROMs), programmable read only memory (PROM), electrically programmable read-only memory (EPROMs), electrically erasable and programmable read only memory (EEPROMs), magnetic card, optical card, any other type of media suitable for storing electronic instructions and capable of being coupled to a system bus, a file system, a network device, a combination of any of the above, etc.

Depending on the embodiment, modules in user system 110 may be concentrated in the same location, for instance in one unit or in various units in proximity of one another, or modules of user system 110 may be dispersed over various locations.

In some cases, user system 110 may comprise fewer, more, and/or different modules than those shown in FIG. 1. Additionally or alternatively, in some cases, the functionality of user system 110 described herein may be divided differently among the modules of system 110. Additionally or alternatively, in some cases, the functionality of user system 110 described herein may be divided into fewer, more and/or different modules than shown in FIG. 1 and/or user system 110 may include additional, less and/or different functionality than described herein. For instance, in some of these cases, user system 110 may be one or more user devices and/or one or more elements which may service multiple user devices, and therefore may also include, if necessary, additional hardware, software, firmware or a combination thereof to perform any additional functionality associated with the user device(s) and/or element(s).

Features of web server 120 may vary depending on the embodiment. For example, web server 120 may be configured to host one or more web sites and/or may be configured to authenticate or not authenticate, if and when necessary, a user whose web client 114 is attempting to access a resource provided by web server 120 (e.g. relating to a hosted web site). Additionally or alternatively, for example, web server 120 may be configured to allow access to the resource which requires web user authentication at least partly based on at least one validation item provided to web server 120 which was protected by validator 116 from possible tampering by web client 114.

Features of validation system 140 (when included) may vary depending on the embodiment. For example, validation system 140 may be configured to generate a validation confirmation (i.e. confirmation that the identity of the user is proven) relating to one or more validation item(s) whose validation is confirmed (e.g. relating to one or more validation item(s) which match with sufficient probability item(s) known to prove the identity of the user). Additionally or alternatively, for example, validation system 140 may be configured to provide validation item(s)(e.g. at least part of one or more validation item(s) whose validation is confirmed and/or at least part of a generated validation confirmation) to user system 110 and/or to web server 120. In some embodiments, part or all of validation system 140 may be included in a gateway, proxy server, other type of server, any other element servicing multiple user devices, etc.

As mentioned above in embodiments which include validation system 140, depending on the embodiment validation system 140 may or may not be at least partly included in web server 120. In embodiments where validation system 140 is configured to provide one or more validation item(s) (e.g. at least part of one or more validation item(s) whose validation is confirmed and/or at least part of a generated validation confirmation) to web server 120, validation system 140 may be configured to provide the validation item(s) to the module(s) in web server 120 which may be configured to perform web user authentication, for instance by transmission via channel 130 (if at least part of validation system 140 is not included in web server 120) and/or for instance by internal transfer (if at least part of validation system 140 is included in web server 120).

Features of communication channel 130 may vary depending on the embodiment. For example, in various embodiments, there may be one or more communication channels) 130 between any pair of elements in network 100, and any communication channel 130 between any pair of elements in network 100 may comprise any suitable infrastructure for network 100 that may provide direct or indirect connectivity between those two elements. It is noted that a communication channel between one pair of elements in network 100 may or may not be the same as a communication channel between another pair of elements in network 100. Communication channel 130 may use for example one or more wired and/or wireless technology/ies. Examples of channel 130 may include cellular network channel, personal area network channel, local area network channel, wide area network channel, internetwork channel, Internet channel, any combination of the above, etc.

FIG. 2 is a flowchart illustration of a method 200 for protecting web authentication, according to some embodiments of the presently disclosed subject matter. In some cases, method 200 may include fewer, more and/or different stages than illustrated in FIG. 2, the stages may be executed in a different order than shown in FIG. 2, stages that are illustrated as being executed sequentially may be executed in parallel, and/or stages that are illustrated as being executed in parallel may be executed sequentially.

In the illustrated embodiments, in stage 204, user system 110 determines that there is a requirement for web authentication of the user (of web client 114) vis-à-vis a web server assumed to be web server 120. For instance, in order for web client 114 to be able to gain access to a resource provided by web server 120 (e.g. relating to a hosted web site), there may be a requirement for user authentication. The subject matter does not limit how the determination of the requirement is made. For example, in various embodiments, web client 114 may determine that there is a requirement and/or validator 116 may determine that there is a requirement. In some examples, the determination may be made by any suitable action, including any of the following actions; using the Uniform Resource Locator (URL) of a webpage of a web site hosted at web server 120 (e.g. matching the URL to a URL in a list of URLs which require authentication), examining the HyperText Markup Language (HTML) content of a webpage of a web site hosted at web server 120, using a script in a webpage of a web site hosted at web server 120, detecting that a password is required (e.g. detecting a password input field in the HTML of a web page of a web site hosted at web server 120), detecting an HTML element with a predefined identifier that is associated with required authentication on a webpage of a website hosted at web server 120, detecting usage of a biometric device such as a fingerprint reader, detecting an application programmable interface API (for instance in Javascript) in a webpage of a website hosted at web server 120 which may be called to continue method 200, detecting that web client 114 is attempting to access a resource relating to a hosted web site which requires user authentication (such as detecting that the user is trying to open a secure message associated with a hosted web site, detecting that the user is trying to confirm an online operation associated with a hosted web site which requires authentication (e.g. transferring funds), detecting that the user is trying to log on to a hosted web site, and/or any other attempt to access a resource provided by web server 120), receiving notification that there is a requirement for web user authentication from web server 120 or validation system 140, a combination of any of the above, etc.

In some cases where web client 114 determined in stage 204 that there was an authentication requirement (and validator 116 did not), web client 114 may call validator 116 to perform stage 208. For instance, web client 114 may call an API that is provided by validator 116. In some examples of this instance, the called API may be the API which was detected in the webpage as discussed above.

In cases where validator 116 determined in stage 204 that there was an authentication requirement (and web client 114 did not), validator 116 may or may not call web client 114 to collect and/or provide validation item(s) to web server 120.

In the illustrated embodiments, in stage 208 validator 116 enables at least one validation item which is provided to web server 120 during the authentication to be protected from possible tampering by web client 114.

The disclosure does not limit how validator 116 may enable a validation item to be protected from tampering, and validator 116 may perform any appropriate action(s) to enable protection from tampering. However for further illustration to the reader some examples are now provided.

For example, one or more validation item(s) may be collected (e.g. via input/output 112, from storer 118 and/or from validation system 140) by validator 116 without involvement of web client 114. In this example, one or more validation item(s) (each of which may include at least part of a validation item collected by validator 116 without involvement of web client 114) may be provided by validator 116 to web server 120 without involvement of web client 114.

Additionally or alternatively, in another example, one or more validation item(s) may be collected (e.g. via input/output 112, from storer 118 and/or from validation system 140) by validator 116 without involvement of web client 114. In this example, one or more validation item(s) (each of which may include at least part of a validation item collected by validator 116 without involvement of web client 114) may be encrypted and/or signed by validator 116. The disclosure does not limit how validator may encrypt and/or sign a particular validation item and any appropriate encrypting and/or signing which protects the validation item from possible tampering by web client 114 may be used. The encrypted and/or signed validation item(s) may then be provided to web server 120 by any module in user system 110 (e.g. web client 114 and/or validator 116) and/or by validation system 140.

Additionally or alternatively, in another example where user system 110 (for instance web client 114 and/or validator 116) provides one or more collected validation item(s) (e.g. collected via input/output 112 and/or from starer 118) to validation system 140, validator 116 may provide instruction to validation system 140 to provide validation item(s) to web server 120. For instance, the validation item(s) which validation system 140 may provide to web server 120 may include at least one of the validation item(s) provided to validation system 140 whose validation is confirmed by validation system 140, or a part thereof, and/or at least part of a validation confirmation generated by validation system 140 relating to at least one validation item(s) whose validation is confirmed. Continuing with this instance, validation system 140 may store or may have access to one or more validation item(s) which are known to prove the identity of the user, and any validation item(s) received from user system 110 which matches with sufficient probability a validation item known to prove the identity of the user may have validation thereof confirmed by validation system 140 (i.e. the matched item may be confirmed as proving the identity of the user). The disclosure does not limit the meaning of the term sufficient probability with respect to matching, and depending on the embodiment, different probability levels may be considered sufficient.

Additionally or alternatively, in another example where user system 110 (for instance web client 114 and/or validator 116) provides one or more collected validation item(s) (e.g. collected via input/output 112 and/or from storer 118) to validation system 140, validator 116 may provide instruction to validation system 140 to encrypt and/or sign at least part of a generated validation confirmation (which is related to at least one of the provided validation item(s) whose validation is confirmed). The disclosure does not limit how validation system 140 may encrypt and/or sign and any appropriate encrypting and/or signing which protects the at least part of the validation confirmation from possible tampering by web client 114 may be used. In this example, the encrypted and/or signed at least part of the validation confirmation may be provided to web server 120 as a validation item by any module in user system 110 (e.g. web client 114 and/or validator 116) and/or by validation system 140.

In any of the above examples, any other validation item(s) which may be collected, may be collected by any module in user system 110 (e.g. web client 114 and/or validator 116) and/or by validation system 140. Additionally or alternatively in any of the above examples, any other validation items) which may be provided to web server 120 during authentication, may be provided by any module in user system 110 (e.g. web client 114 and/or validator 116) and/or by validation system 140. Additionally or alternatively in any of the above examples, any other validation item(s) which may be provided to web server 120 during authentication, may or may not be encrypted and/or signed.

Although as mentioned above, when encrypting and/or signing is performed, any encrypting and/or signing which protects from tampering by web client 114 may be used, for further illustration to the reader, an example of a possible encryption scheme is now presented. Validator 116 or validation system 140 may receive a one time piece of data which may be viewed as an authentication request identifier from web server 120. For instance, the identifier may be received as part of an HTTP response of a webpage before authentication is required, as part of the HTML data of a previously accessed webpage, using an API, during a communication session (e.g. over HTTPS) between validator 116 or validation system 140 and web server 120 in which an authentication request identifier is sent by web server 120, during a communication session between web server 120 and web client 114 (e.g. HTTP header, cookie, in the HTML content) where validator 116 grabs the authentication request identifier when activated, and/or in any other manner. Prior to providing a particular validation item to web server 120, validator 116 or validation system 140 may include the authentication request identifier in the validation item and encrypt the validation item with a public key associated with web server 120. When web server 120 receives the validation item during authentication, web server 120 may decrypt the validation item with its own private key, and verify that the authentication request identifier has not been previously used, has not timed out, is received from an IP address of user system 110 or validation system 140, is related to the current authentication requirement, or may verify any combination of the above, etc. In this way, if a compromised web client 114 tampers with the validation item, the tampering may be discovered if the authentication request identifier has already been used, if the authentication request identifier has timed out, if the authentication request was sent from an incorrect IP address, if the authentication request identifier related to a different authentication requirement, or due to any combination of the above, etc.

Validation item(s) which may be collected by user system 110 is/are not limited by the currently disclosed subject matter and may include any item which validates (i.e. proves the identity) of the user. Examples of validation items may include item(s) that the user knows (e.g. password, pass-phrase, personal identification number, challenge response, etc), item(s) that the user has (e.g. hardware token, software token, etc), a biometric item (e.g. fingerprint), a one-time generated password, a validation confirmation or a part thereof (e.g. from validation system 140), any combination of the above, etc. In embodiments where network 100 includes validation system 140, any particular collected validation item may or may not have validation thereof confirmed by validation system 140.

In some cases, user system 110 may collect at least one validation item(s) by outputting a user interface on user input/output 112 in order to receive validation item(s) from the user (e.g. inputted via user input/output 112).

In some cases, user system 110 may collect at least one validation item(s) by retrieving the item(s) from storer 118, either directly, using a hardware device, and/or using network communication, for instance if at least part of storer 118 is located at an external server.

In some cases where network 100 includes validation system 140, validation system 140 may receive one or more collected validation item(s) from user system 110 and may generate a validation confirmation relating to at least one of the received validation item(s) whose validation is confirmed. For instance, at least one of the validation item(s) retrieved from starer 118 and/or inputted by the user, may be transmitted by user system 110 to validation system 140. Validation system 140 may then confirm or not confirm validation, for instance by comparing the transmitted validation item(s) against validation item(s) for the user which may be known to prove the identity of the user (e.g. which validation system 140 may store or may have access to), and determining if matching with sufficient probability or not. Additionally or alternatively, validation system 140 may or may not generate a validation confirmation relating to validation item(s) whose validation is confirmed. If a validation confirmation is generated, validation system 140 may or may not transmit at least part of the validation confirmation to user system 110. Assuming at least part of the confirmation is transmitted to user system 110 (thereby allowing user system 110 to collect the at least part of the confirmation as a validation item), validation system 140 may or may not be configured to provide the confirmation or part thereof only to validator 116 and not to web client 114. Additionally or alternatively, assuming at least part of the confirmation is transmitted to user system 110, validation system 140 may or may not encrypt and/or sign the at least part of the confirmation, for instance depending on whether or not instructed to encrypt and/or sign by validator 116. Additionally or alternatively, validation system 140 may or may not provide validation item(s) (e.g. at least part of a validation confirmation, if generated-optionally signed and/or encrypted, and/or at least part of each of one or more of the item(s) received from user system 110 whose validation is confirmed) to web server 120. For instance, validation system 140 may provide validation item(s) to web server 120 if instructed to do so by validator 116. In embodiments where validation system 140 may not confirm validation of certain transmitted validation item(s) (for instance because one or more of the item(s) transmitted to validation system 140 may not match with sufficient probability validation item(s) known to prove the identity of the user), validation system 140 may or may not return a warning to user system 110 (e.g. to validator 116) and/or to web server 120.

In embodiments where user system 110 provides one or more validation item(s) to web server 120 during web user authentication, the provided validation item(s) may or may not comprise all validation item(s)collected by user system 110 (e.g. from storer 118, from user, and/or from validation system 140), in the entirety thereof. For instance, in some cases the entirety of all collected validation item(s) may be transmitted even if not all are necessary credentials for authentication, whereas in other cases only those collected validation item(s) or part thereof which may be necessary credentials for authentication (and which may not necessarily include all of the collected item(s) in entirety thereof) may be provided.

Depending on the embodiment, the validation item(s) which may be provided (e.g. by user system 110 and/or validation system 140) to a web server such as web server 120 during web user authentication may or may not vary depending on the web server and/or resource for which authentication is required. Depending on the embodiment, the validation item(s) which may be provided to web server 120 during web user authentication may constitute all of the credential(s) for authentication, may constitute only a subset of the credential(s) for authentication, or may constitute more than all of the credential(s) for authentication. Depending on the embodiment, validation item(s) which may be provided to web server 120, may be provided at the same time or at different phases (with latter phase(s) always occurring or only optionally occurring, for instance only occurring if previously provided credentials were not accepted by web server 120).

As mentioned above, authentication may include provision of user credential(s) on one end, and acceptance of the credential(s) on the part of a web server such as web server 120 on the other end. If the user is authenticated (i.e. the credentials is/are accepted) then web server 120 may allow access to the resource for which there is an authentication requirement. If the user is not authenticated (i.e. the credentials is/are not accepted), then web server 120 may not allow access to the resource for which there is an authentication requirement. In method 200, web server 120 may receive one or more validation items from user system 110 and/or validation system 140. At least one of the received validation item(s) may have been protected from possible tampering by web client 114, and therefore may be assumed to be credential(s) acceptable to web server 120. Therefore web server 120 may allow access to the resource by web client 114, at least partly based on this/these credential(s). It is noted that the decision by web server 120 to allow access may optionally also be based on other credential(s) not related to received validation item(s) which may have been protected from possible tampering by web client 114.

It will also be understood that in some embodiments a system or part of a system according to the presently disclosed subject matter may be a suitably programmed machine. Likewise, some embodiments of the presently disclosed subject matter contemplate a computer program being readable by a machine for executing a method of the presently disclosed subject matter. Some embodiments of the presently disclosed subject matter further contemplate a machine-useable medium tangibly embodying program code readable by the machine for executing a method of the presently disclosed subject matter.

While the presently disclosed subject matter has been shown and described with respect to particular embodiments, it is not thus limited. Numerous modifications, changes and improvements within the scope of the presently disclosed subject matter will now occur to the reader.

1. A system for protecting web authentication, comprising:
a web client operable to attempt to gain access to a resource provided by a web server which requires web user authentication; and
a validator, external to said web client, operable to enable at least one validation item which is provided to said web server during web user authentication to be protected from possible tampering by said web client.

2. The system of claim 1, wherein said system is further operable to collect at least one validation item and provide at least one collected validation item to a validation system, thereby allowing said validation system to generate a validation confirmation relating to at least one validation item provided to said validation system whose validation is confirmed.

3. The system of claim 2, wherein said validator being operable to enable includes: being operable to provide instruction to said validation system to provide to said web server at least one validation item, each comprising at least part of a validation item which was provided to said validation system and whose validation is confirmed or at least part of said validation confirmation.

4. The system of claim 2, wherein said validator being operable to enable includes: being operable to collect as a validation item, without involvement of said web client, at least part of said validation confirmation, and to provide said at least part of said validation confirmation to said web server without involvement of said web client.

5. The system of claim 2, wherein said validator being operable to enable includes: being operable to provide instruction to said validation system to encrypt and/or sign at least part of said validation confirmation.

6. The system of claim 5, wherein said web client is further operable to provide said encrypted and/or signed at least part of said validation confirmation to said web server.

7. The system of claim 1, further comprising:
a storer operable to store at least one validation item, wherein said system is further operable to collect at least one of said at least one stored validation item.

8. The system of claim 1, further comprising:
a user input operable to input at least one validation item from said user, wherein said system is further operable to collect at least one of said at least one inputted validation item.

9. The system of claim 1, wherein said validator being operable to enable includes:
being operable to collect at least one validation item without involvement of said web client and to provide to said web server without involvement of said web client at least one validation item, each comprising at least part of a collected validation item.

10. The system of claim 1, wherein said validator being operable to enable includes: being operable to collect without involvement of said web client at least one validation item, and to encrypt and/or sign at least one validation item, each comprising at least part of a collected validation item.

11. The system of claim 10, wherein said web client is further operable to provide at least one encrypted and/or signed validation item to said web server.

12. The system of claim 1, wherein said web client is further operable to collect at least one validation item.

13. The system of claim 1, wherein at least one validation item which is provided to said web server during said web user authentication is provided by said web client.

14. The system of claim 1, wherein said system is further operable to determine that there is an authentication requirement.

15. The system of claim 14, wherein said authentication requirement is determined by performing at least one action selected from a group comprising: using a URL of a webpage of a web site hosted at said web server, examining HTML content of a webpage of a web site hosted at said web server, using a script in a webpage of a web site hosted at said web server, detecting that a password is required, detecting an HTML element with a predefined identifier that is associated with required authentication on a webpage of a website hosted at said web server, detecting usage of a biometric device such as a fingerprint reader, detecting an application programmable interface API in a webpage of a website hosted at said web server, detecting that said user is trying to open a secure message associated with a hosted web site, detecting that said user is trying to confirm an online operation associated with a hosted web site which requires authentication, detecting that said user is trying to log on to a hosted web site, detecting that said web client is attempting to access any resource relating to a hosted web site which requires user authentication, or receiving notification that there is a requirement for authentication from said web server or from a validation system.

16. The system of claim 14, wherein said validator is operable to determine an authentication requirement.

17. The system of claim 14, wherein said web client is operable to determine an authentication requirement.

18. The system of claim 1, further comprising: a validation system operable to generate a validation confirmation relating to at least one validation item provided to said validation system whose validation is confirmed.

19. The system of claim 1, further comprising: said web server operable to receive at least one provided validation item which was protected from possible tampering by said client and to allow access to said resource at least partly based on said at least one provided validation item.

20. The system of claim 1, being at least one user device, and if necessary further comprising additional hardware, software, firmware, or a combination thereof which enables said system to perform any additional functionality associated with said at least one user device.

21. The system of claim 1, being at least one element which services multiple user devices, and if necessary further comprising additional hardware, software, firmware, or a combination thereof which enables said system to perform any additional functionality associated with said at least one element.

22. A validation system, operable to receive at least one validation item from a user system, to generate a validation confirmation based on at least one of said at least one received validation item whose validation is confirmed, and to provide at least part of said validation confirmation to said user system or to a web server, said at least part of said validation confirmation being provided by said user system or said validation system to said web server during web user authentication relating to an attempt by a web client in said user system to gain access to a resource provided by said web server, wherein if said at least part of said validation confirmation is provided by said validation system to said user system then said at least part of said validation confirmation is encrypted and/or signed by said validation system, or said at least part of said validation confirmation is handled at said user system without involvement of said web client.

23. The system of claim 22, wherein said validation system is not included in said web server.

24. The system of claim 22, wherein said validation system is included in said web server.

25. A web server, operable to receive at least one validation item from a user system or from a validation system, wherein a validator which is external to a web client on said user system had enabled at least one of said at least one validation item to be protected from possible tampering by said web client, and wherein said web server is further operable to allow access to a resource which requires web user authentication at least partly based on said at least one of said at least one validation item.

26. A method of protecting web authentication, comprising:
determining that there is an online authentication requirement relating to a resource provided by a web server to which a web client is attempting to gain access; and
enabling at least one validation item which is provided to said web server during web user authentication to be protected from possible tampering by said web client.

27. The method of claim 26, further comprising: providing at least one validation item to a validation system, thereby allowing said validation system to generate a validation confirmation relating to at least one validation item provided to said validation system whose validation is confirmed.

28. The method of claim 27, wherein said enabling includes: providing instruction to said validation system to provide to said web server at least one validation item, each comprising at least part of a validation item which was provided to said validation system and whose validation is confirmed or at least part of said validation confirmation.

29. The method of claim 27, wherein said enabling includes: collecting as a validation item, without involvement of said web client, at least part of said validation confirmation, and providing said at least part of said validation confirmation to said web server without involvement of said web client.

30. The method of claim 27, wherein said enabling includes: providing instruction to said validation system to encrypt and/or sign at least part of said validation confirmation.

31. The method of claim 26, further comprising: collecting at least one validation item by retrieving said at least one item which had been stored.

32. The method of claim 26, further comprising: collecting at least one validation item from a user.

33. The method of claim 26, wherein said enabling includes: collecting without involvement of said web client at least one validation item and providing to said web server without involvement of said web client at least one validation item, each comprising at least part of a collected validation item.

34. The method of claim 26, wherein said enabling includes: collecting without involvement of said web client at least one validation item, and encrypting and/or signing at least one validation item, each comprising at least part of a collected validation item.

35. The method of claim 26, further comprising: generating a validation confirmation relating to at least one collected validation item whose validation is confirmed.

36. The method of claim 26, further comprising: allowing access to said resource based at least partly on at least one provided validation item which was protected from possible tampering by said client

37. The method of claim 26, wherein said authentication requirement is determined by performing at least one action selected from a group comprising: using a URL of a webpage of a web site hosted at said web server, examining HTML content of a webpage of a web site hosted at said web server, using a script in a webpage of a web site hosted at said web server, detecting that a password is required, detecting an HTML element with a predefined identifier that is associated with required authentication on a webpage of a website hosted at said web server, detecting usage of a biometric device such as a fingerprint reader, detecting an application programmable interface API in a webpage of a website hosted at said web server detecting that said user is trying to open a secure message associated with a hosted web site, detecting that said user is trying to confirm an online operation associated with a hosted web site which requires authentication, detecting that said user is trying to log on to a hosted web site, detecting that said web client is attempting to access any resource relating to a hosted web site which requires user authentication, or receiving notification that there is a requirement for authentication from said web server or from a validation system.

38. A validation method, comprising:
receiving at least one validation item from a user system;
generating a validation confirmation based on at least one of said at least one received validation item whose validation is confirmed; and
providing at least part of said validation confirmation to said user system or to a web server;
wherein said at least part of said validation confirmation is provided by said user system or said validation system to said web server during web user authentication relating to an attempt by a web client in said user system to gain access to a resource provided by said web server; and
wherein if said at least part of said validation confirmation is provided by said validation system to said user system then said at least part of said validation confirmation is encrypted and/or signed by said validation system, or said at least part of said validation confirmation is handled at said user system without involvement of said web client.

39. A method of allowing access to a resource provided by a web server which requires user authentication, comprising:
receiving at least one validation item from a user system or from a validation system, wherein a validator which is external to a web client on said user system has enabled at least one of said at least one validation item to be protected from possible tampering by said web client; and
allowing access to a resource which requires web user authentication at least partly based on said at least one of said at least one validation item.

40. A computer program product comprising a computer useable medium having computer readable program code embodied therein for protecting web authentication, the computer program product comprising:
computer readable program code for causing the computer to determine that there is an online authentication requirement relating to a resource provided by a web server to which a web client is attempting to gain access; and
computer readable program code for causing the computer to enable at least one validation item which is provided to said web server during web user authentication to be protected from possible tampering by said web client.

41. A computer program product comprising a computer useable medium having computer readable program code embodied therein, the computer program product comprising:
computer readable program code for causing the computer to receive at least one validation item from a user system;
computer readable program code for causing the computer to generate a validation confirmation based on at least one of said received validation item whose validation is confirmed; and
computer readable program code for causing the computer to provide at least part of said validation confirmation to said user system or to a web server;
wherein said at least part of said validation confirmation is provided by said user system or said validation system to said web server during web user authentication relating to an attempt by a web client in said user system to gain access to a resource provided by said web server; and
wherein if said at least part of said validation confirmation is provided by said validation system to said user system then said at least part of said validation confirmation is encrypted and/or signed by said validation system, or said at least part of said validation confirmation is handled at said user system without involvement of said web client.

42. A computer program product comprising a computer useable medium having computer readable program code embodied therein of allowing access to a resource provided by a web server which requires user authentication, the computer program product comprising:
computer readable program code for causing the computer to receive at least one validation item from a user system or from a validation system, wherein a validator which is external to a web client on said user system has enabled at least one of said at least one validation item to be protected from possible tampering by said web client; and
computer readable program code for causing the computer to allow access to a resource which requires web user authentication at least partly based on said at least one of said at least one validation item.
